(19) United States
(12) Patent Application Publication
(10) Pub. No.: US 2003/0004798 A1
(43) Pub. Date: Jan. 2, 2003

(54) Method and apparatus for offering enticements

(75) Inventors: Kevin P. McAuliffe, Cortlandt Manor, NY (US); Robert M. Szabo, Boca Raton, FL (US); James J. Toohey, Boca Raton, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 09/897,694

(22) Filed: Jul. 2, 2001

(51) Int. Cl. G06F 17/60

(52) U.S. Cl. 705/14; 705/26

(57) ABSTRACT

In an electronic commerce system, a method of offering an enticement to a consumer during a purchase transaction can include identifying a first item having been selected for purchase by the consumer from an electronic commerce site. Enticement rules, which can specify one or more enticements can be consulted. The method further can include determining one of the enticements based upon the enticement rules and the first item. The enticement can provide the consumer with a buying opportunity relating to a second item associated with the first item. Also, the enticement can be presented to the consumer.

### BACKGROUND OF THE INVENTION

1. Technical Field

This invention relates to the field of electronic commerce, and more particularly, to offering enticements to consumers to stimulate commerce.

2. Description of the Related Art

Advertising can be an important aspect of any successful business. Differing methods of advertising are continually devised to entice consumers into visiting a merchant's store. Once inside, the consumer further must be enticed to make a purchase. Effective advertising can ensure that the consumer's visit to a storefront ultimately results in a purchase.

Merchants have long realized the significant opportunity to sell the consumer additional goods or services once the consumer has decided to make a purchase. Whether the consumer is psychologically predisposed to purchase more after initially deciding to purchase; the consumer feels as though the purchase of additional and related goods is a logical decision; or the consumer merely is persuaded to purchase a more expensive model than originally intended, the skilled merchant can be positioned to offer enticements to capitalize on that opportunity. For example, when purchasing shoes, a salesman can offer the consumer complementary products such as shoe polish or additional shoe laces. Other examples can include selling insurance for large ticket items such as appliances after the consumer has decided to purchase the appliance. Notably, at the time of purchase, especially with regard to large ticket items, the consumer can be particularly sensitive to the risk of loss. Still, the salesperson can “up-sell” the consumer by offering an enhanced product or service such as a more expensive shoe.

Though many varieties of enticements can be offered to consumers, effective enticements typically are offered after the consumer has made an initial decision to make a purchase. Despite the fact that such enticement techniques can benefit both so called brick and mortar storefronts and electronic commerce storefronts alike, brick and mortar storefronts have been the beneficiaries of the aforementioned selling techniques.

### SUMMARY OF THE INVENTION

The invention concerns a method and system for providing enticements to consumers in an electronic storefront once the consumer has decided to make a purchase. The decision to make a purchase can be indicated by the placement of a good or service, collectively referred to as items, into an electronic shopping cart. Specifically, the invention can identify items in an electronic shopping cart system. After consulting enticement rules specifying enticements corresponding to the identified items and the merchant's current inventory, the invention can provide the consumer with an enticement. The enticements can provide consumers with an opportunity to buy additional items which can be complementary to the items being purchased. Additionally, the enticements can entice the consumer to purchase a more expensive item alternative, referred to as up-selling; or entice the consumer to purchase a different brand item alternative, referred to as cross-selling.

One aspect of the invention can be a method of offering an enticement to a consumer during a purchase transaction in a electronic commerce system. The method can include identifying a first item having been selected for purchase by the consumer from an electronic commerce site. Similarly, the first item can be identified by a point-of-sale system within a business outlet. Enticement rules, which can specify one or more enticements can be consulted. The enticement rules can be contained within an electronic data source. One of the enticements can be determined based upon the enticement rules and the first item. Notably, selected ones of the one or more enticements can be filtered based upon information corresponding to the consumer using an intelligent buyer agent. The enticement can provide the consumer with a buying opportunity relating to a second item associated with the first item. The enticement can be presented to the consumer and can be an in stock item. Alternatively, the presenting step can occur after completion of the purchase transaction. The method further can include receiving information specifying the enticement rules from a merchant.

Another aspect of the invention can include the situation wherein the consumer returns the first item. Accordingly, the invention can include identifying the first item having been selected for return by the consumer and altering the presented enticement to the consumer responsive to identifying the first item as being selected for return. Still, the consumer can return the second item offered as an enticement. In that case, the second item can be identified wherein the second item was selected for return by the consumer. Accordingly, the presented enticement can be altered responsive to identifying the second item as being selected for return.

Another aspect of the invention can include a method of offering an enticement to a consumer. In that case, an order for a first item selected for purchase by a consumer can be received. The consumer can be at a location remote from a check-out counter in a business outlet. The first item can be identified from an electronic data source and enticement rules can be consulted. The enticement rules can specify one or more enticements. One of the enticements can be determined based upon the enticement rules and the first item. The enticement can provide the consumer with a buying opportunity relating to a second item associated with the first item. The second item may or may not be in stock. The enticement can be presented to the consumer. Notably, if the consumer decides to return the first item, that item can be identified as being selected for return by the consumer. Accordingly, the presented enticement can be altered responsive to identifying the first item as being selected for return. Similarly, if the consumer decides to return the second item, the presented enticement can be altered responsive to identifying the second item as being selected for return.

Another aspect of the invention can include a method of offering an enticement to a consumer in an electronic commerce system. The method can include identifying a first item from an electronic data source wherein the first item has been selected for purchase by the consumer through a first channel of communication. Enticement rules can be consulted wherein the enticement rules can specify one or more enticements. One of the enticements can be determined based upon the enticement rules and the first item. The enticement can provide the consumer with a buying opportunity relating to a second item associated with the first item, which can be in stock. The enticement can be presented to the consumer and one of the items can be identified as being selected for return by the consumer through a second channel of communication. Accordingly, the enticement can be altered responsive to the identifying one of the items as being selected for return.

Another aspect of the invention can include an electronic enticement system for offering an enticement to a consumer during a purchase transaction. The system can include an enticement rules data source comprising enticement rules. The enticement rules can specify at least one enticement from an enticement data source to be offered to the consumer. An enticement engine also can be included. The enticement engine can be communicatively linked to the enticement rules data source and an electronic commerce site. Alternatively, the enticement engine can be communicatively linked to a back-end processing system for processing purchase, returns, and other financial transactions. The enticement engine can interpret the enticement rules and select at least one enticement associated with items selected for purchase from the electronic commerce site.

Another embodiment of the system can include an electronic commerce site including the enticement data source and an inventory data source including stocked items. Further, an intelligent buyer agent can be included. The intelligent buyer agent can include consumer information corresponding to the consumer for determining selected ones of the at least one enticement according the consumer information.

### BRIEF DESCRIPTION OF THE DRAWINGS

There are shown in the drawings embodiments which are presently preferred, it being understood, however, that the invention is not so limited to the precise arrangements and instrumentalities shown.

FIG. 1 is a pictorial representation of an exemplary system for use with the invention disclosed herein.

FIG. 2 is a schematic diagram illustrating an exemplary enticement system in conjunction with an exemplary electronic commerce storefront.

FIG. 3 is work flow diagram illustrating aspects of the enticement system disclosed herein.

FIG. 4 is a flow chart illustrating a process of offering enticements to consumers.

### DETAILED DESCRIPTION OF THE INVENTION

The invention concerns a method and system for providing enticements to consumers in an electronic storefront. In particular, once the consumer has decided to make a purchase, which can be indicated by the placement of a good or service into an electronic shopping cart, the invention can determine one or more enticements relating to the items being purchased. Specifically, the invention can identify goods and services, collectively referred to as items, in an electronic shopping cart system. After consulting one or more enticement rules specifying which enticements correspond to the consumer transaction and the merchant's current inventory, the invention can provide the consumer with an enticement. The enticements can provide consumers with an opportunity to buy additional items which can be complementary to the items being purchased. Additionally, the enticements can entice the consumer to purchase a more expensive item alternative, referred to as up-selling; or entice the consumer to purchase a different brand item alternative, referred to as cross-selling. Regardless, the enticements can present a buying opportunity relating to additional or alternative items. It should be appreciated that the merchant can determine the content of the enticement. Thus, the merchant can determine whether special pricing, financing, or other incentives can be offered to the consumer.

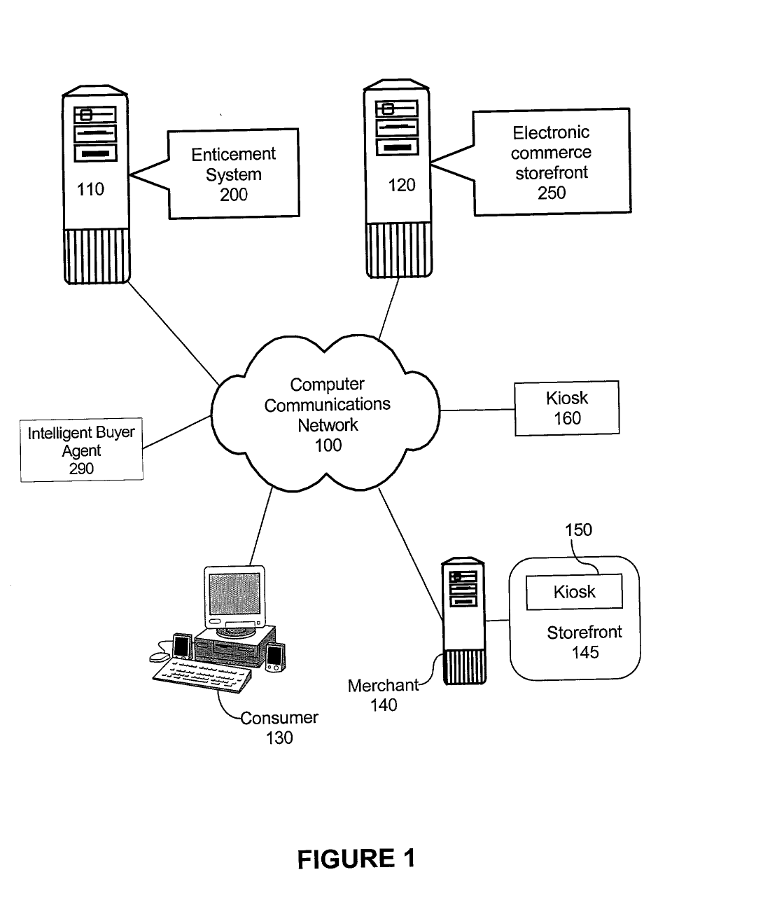

FIG. 1 is a pictorial representation of an exemplary system including servers 110 and 120, an optional intelligent buyer agent 290 (to be discussed later), a consumer computer system 130, and a merchant computer system 140, each communicatively linked through a computer communications network 100. The merchant computer system can connect a brick and mortar storefront 145 operated by the merchant to the computer communications network. For example, the computer communications network 100 can be the Internet where communication can be facilitated using TCP/IP, HTTP, and FTP protocols, each well known in the art. Alternatively, communication can be facilitated through direct network access, a local area network, a wide area network, an Integrated Service Digital Network (ISDN) connection, or a series of direct dial up connections initiated by the merchant and consumer computer systems 130 and 140 respectively. Any suitable method of connecting computers in a computer communications network can be used as well as any suitable network protocol for information exchange such as electronic data interchange (EDI) as is commonly used in business applications.

Server 110 can include an enticement system 200 and server 120 can include an electronic commerce storefront 250 (e-commerce site). Servers 110 and 120 can be application servers, commerce servers, database servers, or any other server that can operate on the Internet. The e-commerce site can be a Web site for example, configured to sell items or otherwise conduct commerce via the Internet. Alternatively, the e-commerce site 250 can be a back-end processing system for processing financial transactions received from point-of-sale computer systems or other remote computer systems. Using consumer computer system 130, a consumer can visit the e-commerce site 250 via the Internet to purchase items being offered for sale. The merchant computer system 140 can be used by a merchant to access the e-commerce site 250 as well as the enticement system 200 to perform administrative functions that can be restricted from consumers and other non-privileged users.

Kiosks 150 and 160, which can be stand-alone computer systems operatively connected to the computer communications network also can be included. As shown in FIG. 1, kiosk 150 can be located within the merchant store 145. Notably, the kiosk 150 can be located remotely from the check out or point-of-sale system within the storefront 145. Kiosk 160 can be located remotely from the storefront 145. Both kiosks 150 and 160 can provide an alternative means for consumers to communicate with the electronic commerce storefront 250 and the check-out or point-of-sale system within storefront 145.

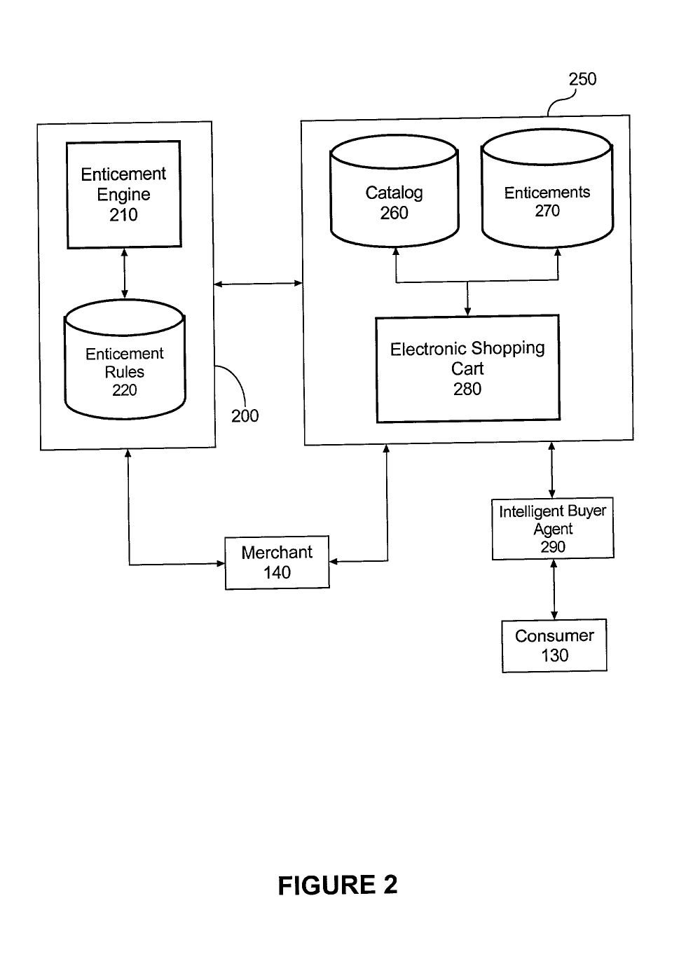

FIG. 2 is a schematic diagram illustrating one embodiment of the invention including the enticement system 200 in conjunction with the e-commerce site 250 of FIG. 1. Although the components of FIG. 2 can be distributed across multiple computer systems within a computer network, the optional intelligent buyer agent 290, the enticement system 200, and the e-commerce site 250 can be located within a single computer system. As shown in FIG. 2, the merchant computer system 140 can communicate with both the enticement system 200 as well as the e-commerce site 250, while the consumer computer system 130 can communicate only with the e-commerce site 250. Accordingly, the enticement system 200 and the e-commerce site 250 can include suitable security protocols preventing unauthorized consumer access to the computer systems. Also, the merchant can be provided secure access to the enticement system 200 and the e-commerce site 250 for administering each of the systems. An intelligent buyer agent 290 further can be included. The computer communications network has been omitted from FIG. 2 for purposes of illustration only.

The e-commerce site 250, similar to a conventional e-commerce Web site, can include a catalog data source 260 and an electronic shopping cart 280. As mentioned, the e-commerce site 250 can include suitable security protocols providing the merchant secure access to the e-commerce site 250 for administration of the e-commerce site 250 and data stored therein. The catalog data source 260 can include an inventory of items being sold by the merchant. The inventory of items can include an indication of which items are currently in stock. The electronic shopping cart 280 can be used to store items selected by a consumer from the catalog data source 260 for a purchase transaction.

The e-commerce site also can include an enticement data source 270. The enticement data source 270 can include one or more enticements corresponding to items listed in the catalog 260. Enticements ultimately can be used to inform consumers of buying opportunities corresponding to the items placed in the consumer's shopping cart 280. For example, enticements can relate to goods and services upgrades, up-sells, cross-brand sells, and other complementary or related items. Specifically, the enticements can be advertisements wherein the merchant can decide the content of the particular enticement being offered. For example, the merchant can program an enticement and determine the price and quantity of a particular item being offered for sale. It should be appreciated that the enticements can be programmed as visual presentations, audio presentations, or any combination of the two, for example, a multi-media presentation of information. In one embodiment, for example, the enticements can be viewed or heard through a browser. The enticements can be programmed by the merchant and updated as deemed necessary by the merchant. In some instances, enticements can be printed out by the consumer or merchant as hard-copies in the form of coupons or vouchers from the consumer or merchant's computer system or a kiosk.

In one embodiment of the invention, the enticements can be limited to stocked items. Alternatively, the enticements can include stocked items as well as out of stock items. Regardless, the merchant can build the enticement data source 270, and therefore, determine the content of the enticement data source 270. For example, the enticements can be a subset or super-set of the merchant's inventory, including goods or services offered by other merchants which relate to the items purchased by the consumer.

As mentioned, in an alternative embodiment of the invention, the e-commerce storefront 250 can be a back-end processing system. In that case, the e-commerce site 250 can interface with the remote kiosk 160, the in-store kiosk 150, the enticement system 200, the intelligent buyer agent 290, and the point-of-sale system within the store. For example, the electronic shopping cart can be an electronic storage device for storing items selected by consumers for purchase through the check-out or point-of-sale system, or one of the kiosks. Notably, the e-commerce storefront 250 can be located on-premises within the storefront 145, for example, within merchant computer system 140. Still, the invention can include both an e-commerce storefront 250 as well as a back-end processing system wherein both systems can be communicatively linked.

Those skilled in the art will recognize that many business enterprises can conduct business through multiple channels which can include e-commerce storefronts or Web sites, kiosks, and brick-and-mortar storefronts or actual business outlets. Further, these channels can have multiple consumer contact points which can be referred to as consumer relationship management outlets. Examples of consumer relationship management outlets can include, but are not limited to, help desks, telephone service calls, in-person service calls, and other forms of consumer contact. In many instances, the channels can be synchronized and function cooperatively as parts of a whole rather than as separate and distinct units.

The enticement system 200 can include an enticement rules data source 220 and an enticement engine 210. The enticement rules data source 220 can include a plurality of rules specifying which enticements from the enticement data source 270 can be provided to the consumer and under what circumstances. For example, the enticement rules can specify the enticements based upon factors such as the type or brand of items in the electronic shopping cart, the total dollar value, as well as other factors including the past purchases and shopping behavior of consumers. For example, the enticement rules can specify that if item X is in the electronic shopping cart, then enticements Y and Z from the enticement data source 270 can be presented to the consumer. Notably, enticements Y and Z can be programmed to offer purchase incentives for items which can be complementary to item X. Also, as mentioned, enticements Y and Z can be attempts to up-sell, cross-sell, or even make favorable financing terms available to the consumer if additional items are purchased. It should be appreciated that the enticement rules can be administered and edited by the merchant. Accordingly, the merchant operating the e-commerce site can control which enticements ultimately are provided to consumers.

The enticement engine 210 can be programmed to communicate with the enticement rules data source 220 and the e-commerce site 250. In particular, the enticement engine can access the contents of the electronic shopping cart 280, the catalog data source 260, and the enticement data source 270. With reference to each of the aforementioned components, the enticement engine 210 can identify one or more enticements from the enticement data source 270 which can be presented to the consumer through the consumer computer system 130.

The enticement engine 210 further can be configured to provide the merchant secure access to the enticement system such that the merchant can administer the enticement rules data source 220 and the enticement data source 270. Similarly, the enticement engine 210 can be configured to securely interact with the e-commerce site 250.

The invention also can include an optional intelligent buyer agent 290. The intelligent buyer agent 290 can be a conventional intelligent agent, as is known in the art. The intelligent buyer agent 290 can be a program that can regularly gather information and perform a service without immediate supervision by the consumer. Specifically, the intelligent buyer agent 290 can utilize previously provided information, for example, consumer registration information, to gather additional data concerning that consumer or additional information of interest to that consumer based upon the registration information. Also, past purchase behavior can be recorded by the intelligent buyer agent 290. Using the gathered information, the intelligent buyer agent 290 effectively can filter a list of enticements before presentation to the consumer. For example, the enticement engine 210 can identify a plurality of enticements based upon the items in the consumer's shopping cart. The intelligent buyer agent 290 can screen out enticements which the agent identifies as inconsistent with the consumer's identified interests and past purchase behavior. Thus, the intelligent buyer agent 290 negotiates on behalf of the buyer to ensure that enticements of interest can be presented to the consumer.

While the intelligent buyer agent 290 is depicted as a program separate from the e-commerce site 250 and the enticement system 200, those skilled in the art will appreciate that due to the autonomous nature of intelligent agents, the intelligent buyer agent 290 can be located at any of a variety of locations within the computer communications network. For example, the intelligent buyer agent 290 can exist within the consumer's Internet service provider, a proxy server, the enticement engine 200, the e-commerce site 250, or at another location within the computer communications network. Similarly, it should be appreciated that although the enticement system 200 and the e-commerce site 250 are shown as separate systems located within separate servers, the two systems can be combined into a single larger, more complex system. Regardless, as mentioned, the intelligent buyer agent 290 is optional. Accordingly, the e-commerce site 250, the enticement system 200, or both can be programmed with the functionality of the intelligent buyer agent 290.

In operation, a consumer using consumer computer system 130 can visit the e-commerce site 250. The consumer can decide to purchase one or more items and place those items into the electronic shopping cart 280. The enticement engine can monitor the electronic shopping cart and use the enticement rules data source 220 and the enticement data source 270 to determine an initial list of enticements for presentation to the consumer. In one embodiment, the enticement engine further can consult the catalog 260 to ensure that products relating to the initial list of enticements are in stock. If not, the enticements corresponding to the out of stock items can be ignored.

The intelligent buyer agent 290 can negotiate with the e-commerce site 250 on behalf of the consumer such that enticements which are determined to be inconsistent with information gathered by the intelligent buyer agent 290 can be discarded. Accordingly, the consumer can be presented with enticements relating to items of interest. The intelligent buyer agent 290 can make counter offers on behalf of the consumer to negotiate with the e-commerce site 250 to obtain a more favorable enticement. Each side can make further counter-offers until an agreement is reached.

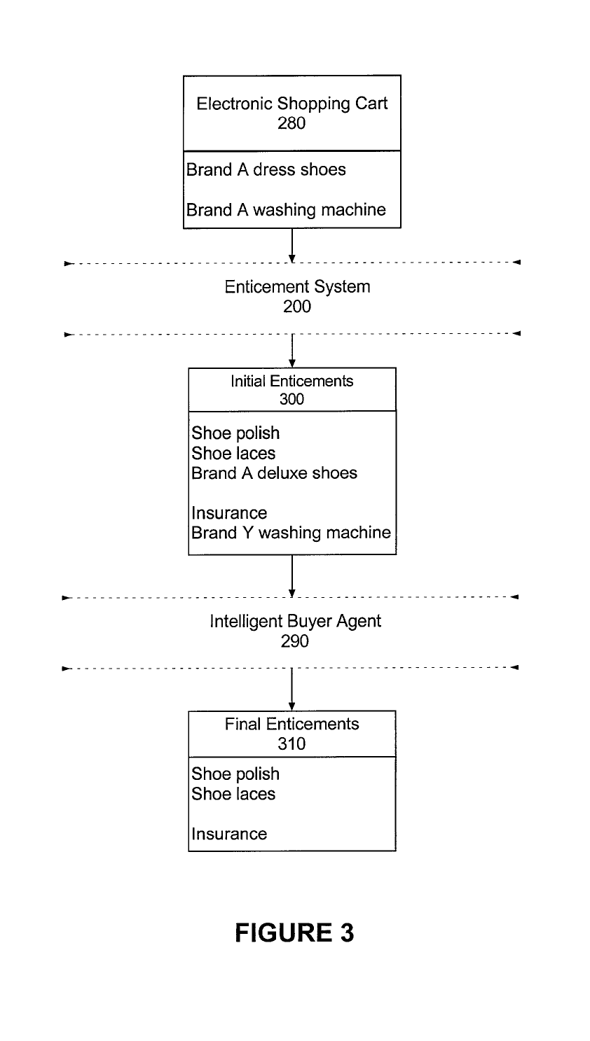

FIG. 3 is a work flow diagram illustrating aspects of the enticement system 200 and the intelligent buyer agent 290 of FIG. 2. FIG. 3 illustrates the condition where a consumer has selected a plurality of items for purchase from an e-commerce site. Accordingly, the electronic shopping cart 280 includes a pair of brand A dress shoes and a brand A washing machine. As illustrated, the enticement system 200 can detect both items within the electronic shopping cart 280 and identify initial enticements 300 from the enticements data source. For example, using the enticement rules, the catalog of stocked items, and the enticement data source, the enticement system has identified shoe polish, shoe laces, and brand A deluxe shoes as enticements for the brand A dress shoes selected for purchase by the consumer. Similarly, insurance and a brand Y washing machine have been identified as enticements corresponding to the washing machine A selected for purchase by the consumer.

Continuing with FIG. 3, brand Y washing machines can be a cross-sell for brand A washing machines. Similarly, brand A deluxe shoes can be an up-sell for brand A shoes. Insurance can be a related product for large ticket consumer appliances and shoe laces and shoe polish can be related products for brand A dress shoes. It should be appreciated that the alternate brand products can be offered as up-sells, cross-sells or as additional items for purchase at a discount. Notably, the merchant determines the content of the enticements, i.e., whether the enticements offer related items at discounts, two-for-one specials, alternatives, or merely provide information. The merchant also determines which enticements correspond to products being purchased through the enticement rules.

The intelligent buyer agent 290 can filter enticements from the initial enticements 300 which do not correspond to consumer information gathered by the intelligent buyer agent 290. Accordingly, a final set of enticements 310 can be presented to the consumer after negotiation with the intelligent buyer agent. As shown in FIG. 3, the intelligent buyer agent 290 has determined that the consumer either dislikes or has no preference for brand A deluxe shoes or brand Y washing machines. Thus, those enticements have been removed from the final enticements list 310. Similarly, the intelligent buyer agent 290 has determined that the consumer prefers or has a purchase history with regard to shoe polish, shoe laces, and insurance.

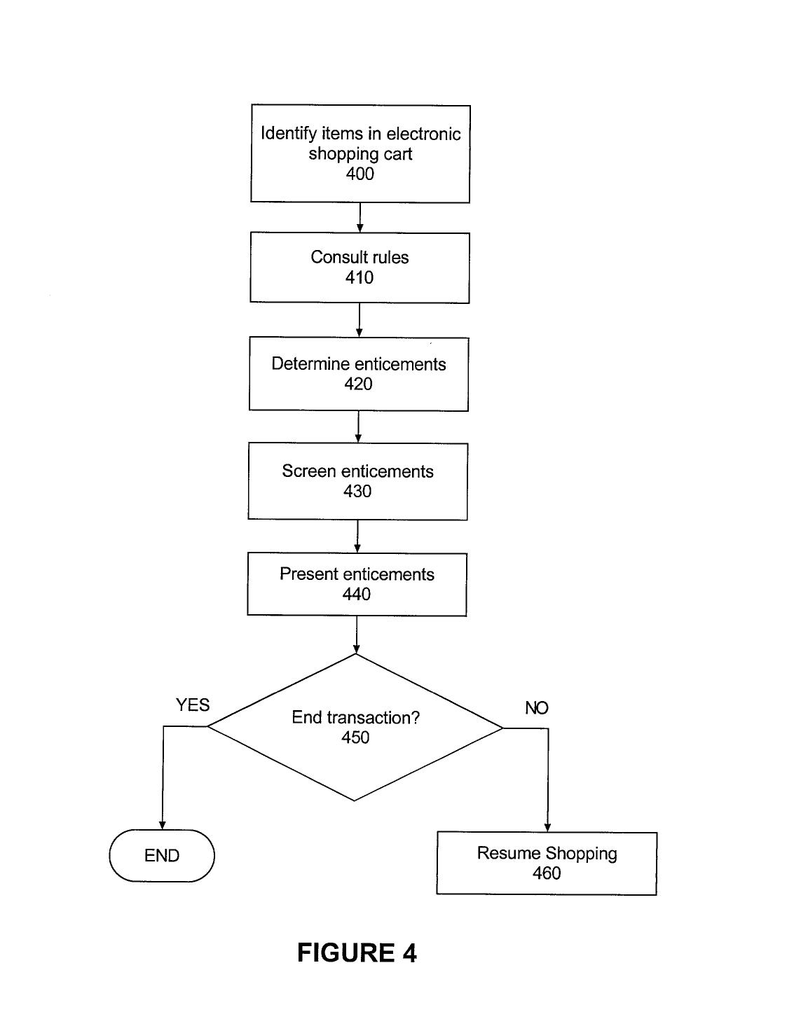

FIG. 4 is a flow chart illustrating a process of offering enticements to consumers as performed using the enticement system 200 of FIG. 2. FIG. 4 can begin in a state wherein the consumer has selected one or more items for purchase and has placed those items in an electronic shopping cart. As mentioned, the items can be selected by a consumer via a kiosk which can be either on or off-site from the merchant storefront, an e-commerce site, or a point-of-sale system within the merchant storefront. Thus, in step 400, the items in the electronic shopping cart can be identified. In step 410, the enticement rules can be consulted to determine the enticements associated with the identified items in the electronic shopping cart.

In step 420, based upon the enticement rules and the available in stock items, the enticements can be determined. The enticements optionally can be screened in step 430 to determine a list of enticements that more closely matches identified user preferences and accumulated user information. For example, the intelligent buyer agent can negotiate with the e-commerce site on behalf of the buyer. As mentioned, the intelligent buyer agent can negotiate with the e-commerce site by making one or more counter-offers to obtain a more favorable enticement. Alternatively, the e-commerce site or the enticement system can selectively filter enticements. Still, as mentioned, the determined enticements need not be screened.

In step 440, the remaining enticements can be presented to the consumer. Notably, the enticements can be presented after one or more items have been placed in the electronic shopping cart. For example, an audio, video, or multi-media advertisement can be presented to the user via the user's browser as the user continues to shop. The enticements can be presented prior to completion of the shopping experience or check-out. Alternatively, the enticements can be presented after completion of the purchase transaction using the aforementioned methods or using electronic mail messages, instant messages, or a confirmation screen. For example, enticements can be sent automatically responsive to a check out or can be sent a predetermined amount of time after a checkout.

In step 450, if the consumer has checked out or otherwise completed the purchase transaction, the method can end. If not, the method can continue to step 460 where the consumer can continue to shop. Accordingly, the method can repeat as necessary, thereby allowing shopping and the offering of enticements to continue until such time as the consumer chooses to complete the purchase transaction. For example, the electronic shopping cart can be checked for additional items until completion of the purchase transaction, the shopping session times out, or the user leaves the e-commerce site.

Another aspect of the invention can include altering an enticement in the event the consumer makes a return. Whether the consumer purchases an item from an e-commerce storefront, the physical business storefront, or through a kiosk, upon returning one or more of the items, the original enticement to the consumer can be altered. For example, the value of the enticement can be increased such that the consumer is provided with additional incentive to keep the purchased items. Alteration of the enticement can include withdrawing the enticement or decreasing the value of the enticement. In either case, the alteration of the enticement can make the return of merchandise more costly to the consumer. Notably, the alteration of the enticement can be responsive to the consumer returning either an item originally selected for purchase or one of the items received through the offering of an enticement. Further, once the item has been identified by one of the merchant systems as a return, despite the manner and location in which the consumer initiated the return, the enticement can be renegotiated between the consumer and the merchant. Accordingly, the consumer can initiate the return via a kiosk, the e-commerce storefront, or within the actual merchant's store, conditioned upon the merchant's willingness to do so.

In any case, the consumer can be presented with another enticement responsive to identifying an item selected for return by the consumer. The enticement can be presented as discussed previously through electronic means or through a hard-copy. Moreover, the enticement can be presented through any of the aforementioned channels having consumer relationship management outlets. Those skilled in the art will recognize that each point of consumer contact can be an opportunity to present the consumer with an enticement.

The present invention can be realized in hardware, software, or a combination of hardware and software. A method and system for providing enticements according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. In an electronic commerce system, a method of offering an enticement to a consumer during a purchase transaction, said method comprising:
identifying a first item having been selected for purchase by said consumer from an electronic commerce site;
consulting enticement rules, said enticement rules specifying one or more enticements;
determining one of said enticements based upon said enticement rules and said first item, said enticement providing said consumer with a buying opportunity relating to a second item associated with said first item; and
presenting said enticement to said consumer.

2. The method of claim 1, wherein said second item is in stock.

3. The method of claim 1, wherein said determining step comprises:
filtering selected ones of said one or more enticements based upon information corresponding to said consumer using an intelligent buyer agent.

4. The method of claim 1, further comprising:
receiving information specifying said enticement rules from a merchant.

5. The method of claim 1, wherein said presenting step occurs after completion of the purchase transaction.

6. The method of claim 1, further comprising:
identifying said first item having been selected for return by said consumer;
altering said presented enticement to said consumer responsive to said identifying said first item as being selected for return.

7. The method of claim 1, further comprising:
identifying said second item having been selected for return by said consumer;
altering said presented enticement to said consumer responsive to said identifying said second item as being selected for return.

8. A method of offering an enticement to a consumer, said method comprising:
receiving an order for a first item selected for purchase by a consumer wherein said consumer is at a location remote from a check-out counter, wherein said check-out counter is located in a business outlet;
identifying said first item from an electronic data source;
consulting enticement rules, said enticement rules specifying one or more enticements;
determining one of said enticements based upon said enticement rules and said first item, said enticement providing said consumer with a buying opportunity relating to a second item associated with said first item; and
presenting said enticement to said consumer.

9. The method of claim 8, wherein said second item is in stock.

10. The method of claim 8, further comprising:
identifying said first item having been selected for return by said consumer;
altering said presented enticement to said consumer responsive to said identifying said first item as being selected for return.

11. The method of claim 8, further comprising:
identifying said second item having been selected for return by said consumer;
altering said presented enticement to said consumer responsive to said identifying said second item as being selected for return.

12. In an electronic commerce system, a method of offering an enticement to a consumer during a purchase transaction, said method comprising:
identifying a first item having been selected for purchase by said consumer from a point-of-sale system in a business outlet;
consulting an electronic data source having enticement rules, said enticement rules specifying one or more enticements;
determining one of said enticements based upon said enticement rules and said first item, said enticement providing said consumer with a buying opportunity relating to a second item associated with said first item; and
presenting said enticement to said consumer.

13. The method of claim 12, wherein said second item is in stock.

14. In an electronic commerce system, a method of offering an enticement to a consumer, said method comprising:
identifying a first item from an electronic data source, said first item having been selected for purchase by said consumer through a first channel of communication;
consulting enticement rules, said enticement rules specifying one or more enticements;
determining one of said enticements based upon said enticement rules and said first item, said enticement providing said consumer with a buying opportunity relating to a second item associated with said first item;
presenting said enticement to said consumer; and
identifying one of said items as being selected for return by said consumer through a second channel of communication and altering said enticement responsive to said identifying one of said items as being selected for return.

15. The method of claim 14, wherein said second item is in stock.

16. An electronic enticement system for offering an enticement to a consumer during a purchase transaction comprising:
an enticement rules data source comprising enticement rules, said enticement rules specifying at least one enticement from an enticement data source to be offered to the consumer; and
an enticement engine communicatively linked to said enticement rules data source and an electronic commerce site, said enticement engine interpreting said enticement rules and selecting said at least one enticement associated with items selected for purchase from said electronic commerce site.

17. The enticement system of claim 16, said electronic commerce site including said enticement data source and an inventory data source including stocked items.

18. The system of claim 16, further comprising:
an intelligent buyer agent including consumer information corresponding to the consumer for determining selected ones of said at least one enticement according to said consumer information.

19. An electronic enticement system for offering an enticement to a consumer during a purchase transaction comprising:
an enticement rules data source comprising enticement rules, said enticement rules specifying at least one enticement from an enticement data source to be offered to the consumer; and
an enticement engine communicatively linked to said enticement rules data source and a back-end transaction processing system, said enticement engine interpreting said enticement rules and selecting said at least one enticement associated with items selected for purchase from said back-end processing system.

20. The electronic enticement system of claim 19, wherein said enticement engine is communicatively linked to a data store having purchase history information and consumer shopping behavior information.

21. A machine-readable storage, having stored thereon a computer program having a plurality of code sections executable by a machine for causing the machine to perform the steps of:
identifying a first item having been selected for purchase by said consumer from an electronic commerce site;
consulting enticement rules, said enticement rules specifying one or more enticements;
determining one of said enticements based upon said enticement rules and said first item, said enticement providing said consumer with a buying opportunity relating to a second item associated with said first item; and
presenting said enticement to said consumer.

22. The machine-readable storage of claim 21, wherein said second item is in stock.

23. The machine-readable storage of claim 21, said determining step further comprising:
filtering selected ones of said one or more enticements based upon information corresponding to said consumer using an intelligent buyer agent.

24. The machine-readable storage of claim 21, further comprising:
receiving information specifying said enticement rules from a merchant.

25. The machine-readable storage of claim 21, wherein said presenting step occurs after completion of the purchase transaction.

26. The machine-readable storage of claim 21, further comprising:
identifying said first item having been selected for return by said consumer;
altering said presented enticement to said consumer responsive to said identifying said first item as being selected for return.

27. The machine-readable storage of claim 21, further comprising:
identifying said second item having been selected for return by said consumer;
altering said presented enticement to said consumer responsive to said identifying said second item as being selected for return.

28. A machine-readable storage, having stored thereon a computer program having a plurality of code sections executable by a machine for causing the machine to perform the steps of:
receiving an order for a first item selected for purchase by a consumer wherein said consumer is at a location remote from a check-out counter, wherein said check-out counter is located in a business outlet;
identifying said first item from an electronic data source;
consulting enticement rules, said enticement rules specifying one or more enticements;
determining one of said enticements based upon said enticement rules and said first item, said enticement providing said consumer with a buying opportunity relating to a second item associated with said first item; and
presenting said enticement to said consumer.

29. The machine-readable storage of claim 28, wherein said second item is in stock.

30. The machine-readable storage of claim 28, further comprising:
identifying said first item having been selected for return by said consumer;
altering said presented enticement to said consumer responsive to said identifying said first item as being selected for return.

31. The machine-readable storage of claim 28, further comprising:
identifying said second item having been selected for return by said consumer;
altering said presented enticement to said consumer responsive to said identifying said second item as being selected for return.

32. A machine-readable storage, having stored thereon a computer program having a plurality of code sections executable by a machine for causing the machine to perform the steps of:
identifying a first item having been selected for purchase by said consumer from a point-of-sale system in a business outlet;
consulting an electronic data source having enticement rules, said enticement rules specifying one or more enticements;
determining one of said enticements based upon said enticement rules and said first item, said enticement providing said consumer with a buying opportunity relating to a second item associated with said first item; and
presenting said enticement to said consumer.

33. The machine-readable storage of claim 32, wherein said second item is in stock.

34. A machine-readable storage, having stored thereon a computer program having a plurality of code sections executable by a machine for causing the machine to perform the steps of:
identifying a first item from an electronic data source, said first item having been selected for purchase by said consumer through a first channel of communication;
consulting enticement rules, said enticement rules specifying one or more enticements;
determining one of said enticements based upon said enticement rules and said first item, said enticement providing said consumer with a buying opportunity relating to a second item associated with said first item;
presenting said enticement to said consumer; and
identifying one of said items as being selected for return by said consumer through a second channel of communication and altering said enticement responsive to said identifying one of said items as being selected for return.

35. The machine-readable storage of claim 34, wherein said second item is in stock.
